(19) United States
(12) Patent Application Publication
(10) Pub. No.: US 2025/0115476 A1
(43) Pub. Date: Apr. 10, 2025

(54) PROCESSES FOR PRODUCING HYDROGEN

(71) Applicant: Saudi Arabian Oil Company, Dhahran (SA)

(72) Inventor: Omer Refa Koseoglu, Dhahran (SA)

(73) Assignee: Saudi Arabian Oil Company, Dhahran (SA)

(21) Appl. No.: 18/484,073

(22) Filed: Oct. 10, 2023

(51) Int. Cl. C01B 3/36; B01D 3/10; B01D 3/14; C01B 3/16; C25B 1/04; C25B 15/08

(52) U.S. Cl. CPC C01B 3/36; B01D 3/10; B01D 3/143; C01B 3/16; C25B 1/04; C25B 15/081; C01B 2203/0255; C01B 2203/0283; C01B 2203/0883; C01B 2203/1076; C01B 2203/1235

(57) ABSTRACT

According to some embodiments, a process for producing hydrogen may comprise operating an electrolysis cell with a source of electricity to produce an oxygen stream and a hydrogen stream from water, reacting a hydrocarbon feedstock with the oxygen stream to partially oxidize the hydrocarbon feedstock, thereby producing a synthesis gas comprising hydrogen and carbon monoxide; passing the synthesis gas and a water stream to a heat exchanger to produce steam and to cool the synthesis gas; and reacting at least a portion of the synthesis gas from the heat exchanger and at least a portion of the steam from the heat exchanger. The source of electricity to the electrolysis cell for the totality of the operation of the electrolysis cell is not produced from energy provided by the combustion of hydrocarbons;

### TECHNICAL FIELD

The present disclosure relates to chemical processing and, more specifically, to processes for the production of hydrogen utilizing water electrolysis.

### BACKGROUND

Hydrogen is growing in importance as a relatively environmentally friendly precursor chemical and fuel. Generally, hydrogen may be produced from water using electrolysis or from hydrocarbons using gasification and the water-gas shift reaction. Historically, hydrogen produced from water electrolysis has been disfavored due to the immense electrical energy required for water electrolysis. Rather, hydrogen has been produced from hydrocarbon gasification and the water-gas shift reaction.

In industry, hydrogen is sometimes identified on a color scale that corresponds to its method of production. For example, “green hydrogen” is hydrogen produced exclusively from water electrolysis using exclusively renewable electricity, and “blue hydrogen” is hydrogen produced from hydrocarbon combustion and carbon capture. Each of the existing hydrogen color types have drawbacks.

### SUMMARY

Conventionally produced “blue hydrogen” is not generally considered as environmentally friendly due to the release of carbon dioxide in its production. On the other hand, “green hydrogen” is unable to make up the shortfalls in hydrogen needs as green hydrogen requires an abundance of renewable electricity that is not currently available in large quantities from the electric grid or otherwise. With this in mind, there is a need for more environmentally friendly hydrogen that is scalable. Accordingly, one or more embodiments of the present disclosure meet this need by providing an integrated process for producing hydrogen comprising both (a) producing hydrogen through hydrocarbon gasification with associated carbon capture and (b) producing hydrogen and oxygen from water in an electrolysis cell wherein the source of electricity to the electrolysis cell for the totality of the process is not produced from energy provided by the combustion of hydrocarbons. Instead, the electricity is derived from some non-hydrocarbon source such as solar, wind, geothermal, etc.

It should be appreciated that the hydrogen produced according to the present methods would not be considered purely “green hydrogen” because the process includes hydrocarbon gasification and the production of hydrocarbons. Additionally, the hydrogen produced according to the presently disclosed methods is not considered purely “blue hydrogen” because the process includes hydrogen produced from water electrolysis using exclusively renewable electricity. Instead, hydrogen produced according to the presently disclosed embodiments may be considered “cyan hydrogen,” where cyan hydrogen refers to a mixture of “green hydrogen” and “blue hydrogen.” On the other hand, if the electricity were produced from the combustion of hydrocarbons (including from steam generated by the combustion of hydrocarbons), the resulting hydrogen would not be produced from water electrolysis using renewable electricity (i.e., “green hydrogen”) and, thus, it would not be possible produce the commercially desired cyan hydrogen embodiments disclosed herein. According to some embodiments of the present disclosure, a process for producing hydrogen may comprise operating an electrolysis cell with a source of electricity to produce an oxygen stream and a hydrogen stream from water, reacting a hydrocarbon feedstock with the oxygen stream to partially oxidize the hydrocarbon feedstock, thereby producing a synthesis gas comprising hydrogen and carbon monoxide; passing the synthesis gas and a water stream to a heat exchanger to produce steam and to cool the synthesis gas; and reacting at least a portion of the synthesis gas from the heat exchanger and at least a portion of the steam from the heat exchanger. The source of electricity to the electrolysis cell for the totality of the operation of the electrolysis cell is not produced from energy provided by the combustion of hydrocarbons;

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 illustrates a process for producing hydrogen, according to some embodiments described herein; and

FIG. 2 illustrates the operation of a hydrocarbon gasification and water-gas shift reactor.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

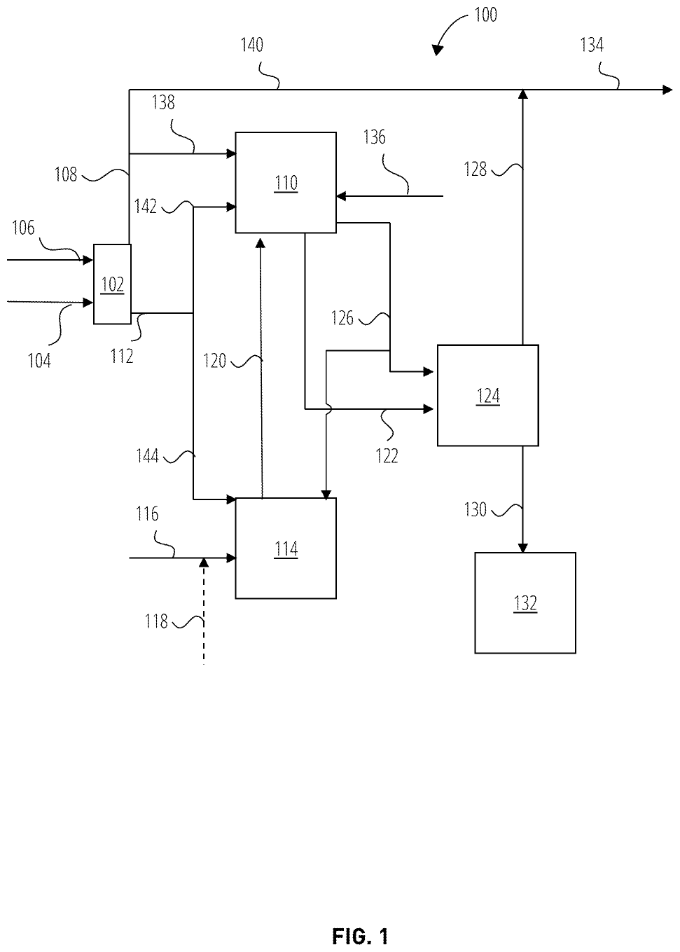

Embodiments of the present disclosure relate to methods of producing hydrogen. In general, and as is discussed herein, the hydrogen production methods comprise both water electrolysis and hydrocarbon oxidation. Description of the embodiments of FIG. 1 may generally apply to the embodiments described herein, as would be understood by those skilled in the art. However, it is contemplated that the methods disclosed and claimed herein may be compatible with other chemical process schemes.

Referring now to FIG. 1, a process for producing hydrogen may occur within a system for producing hydrogen 100. The process for producing hydrogen may comprise operating an electrolysis cell 102 with a source of electricity 104 to produce an oxygen stream 112 and a hydrogen stream 108 from water 106, wherein the source of electricity to the electrolysis cell for the totality of the process is not produced from energy provided by the combustion of hydrocarbons. The process for producing hydrogen may further comprise partially oxidizing a hydrocarbon feedstock 116 with the oxygen stream 112 (such as in a partial oxidation gasification reactor 114) to produce a synthesis gas 120 comprising hydrogen and carbon monoxide; passing the synthesis gas 120 and a water stream 136 to a heat exchanger 110 to produce steam 126 and cool the synthesis gas; and introducing at least a portion of the cooled synthesis gas 122 from the heat exchanger 110, and at least a portion of the steam 126 from the heat exchanger 110 into a water-gas shift reactor 124 to produce carbon dioxide (CO₂) 130 and additional hydrogen 128.

As used in the present disclosure, the term “crude oil” refers to a mixture of petroleum liquids and gases, including impurities, such as sulfur-containing compounds, nitrogen-containing compounds, and metal compounds, extracted directly from a subterranean formation or received from a desalting unit without having any fractions, such as naphtha, separated by distillation.

The electrolysis of water refers to the decomposition of water into oxygen gas and hydrogen gas by passing an electric current through the water. Generally, electrochemical cells configured for the production of hydrogen have two electrodes: a cathode and an anode. The electrodes are placed in the water and externally connected with a power supply. At a critical voltage, hydrogen and oxygen are produced. The reactions proceed as follows:

2H⁺(aq)+2e⁻→H₂(g) (1)

4OH⁻(aq)→2H₂O+O₂(g)+4e⁻ (2)

The minimum necessary cell voltage for the start of electrolysis is referred to as Eceu.

The electrolysis cell 102 may be characterized by the chemistry of the electrolyte. For example, the electrolysis cell 102 may be an alkaline electrolysis cell comprising a porous separator and an alkaline electrolyte or a proton exchange membrane (PEM) electrolysis cell comprising an acidic membrane separator which also functions as an acidic electrolyte, or a solid oxide electrolysis cell comprising a solid oxide electrolyte (such as yttrium-stabilized-zirconia).

In the electrolysis cell 102, an anode electrode and a cathode electrode may be placed in a water with a separator (such as a membrane) between the two electrodes. The anodes and the cathodes may be unipolar or bipolar. When the electrodes are unipolar, each electrode functions as a terminal electrode. Bipolar electrolyzers may include many cells operating in series. Each electrode in the bipolar electrolyzer, with the exception of the two terminal electrodes, may function as a cathode on one side of the electrode and an anode at the other side of the electrode.

The electrolysis cell 102 may be operated at a temperature in the range from 10° C. to 99° C., such as from 10° C. to 90° C., from 10° C. to 80° C., from 10° C. to 70° C., from 20° C. to 99° C., from 20° C. to 90° C., from 20° C. to 80° C., from 20° C. to 70° C., from 20° C. to 50° C., from 30° C. to 99° C., from 30° C. to 90° C., from 30° C. to 80° C., from 30° C. to 70° C., from 50° C. to 99° C., from 50° C. to 90° C., from 50° C. to 80° C., from 50° C. to 70° C., or any subset thereof. In embodiments, the electrolysis cell 102 may be an alkaline or PEM electrolysis cell and the operating temperature may be in the range from 10° C. to 99° C. In embodiments, the electrolysis cell 102 may be a solid oxide electrolysis cell operated at a temperature in the range from 500° C. to 900° C.

The electrolysis cell 102 may be operated at a hydrogen pressure of from 1 bar to 500 bar, such as from 1 bar to 200 bar, from 1 bar to 50 bar, from 1 bar to 30 bar, from 1 bar to 25 bar, from 1 bar to 20 bar, from 1 bar to 15 bar, from 1 bar to 10 bar, from 5 bar to 30 bar, from 10 bar to 30 bar, from 20 bar to 30 bar, from 20 bar to 500 bar, from 30 bar to 500 bar, from 50 bar to 500 bar, from 100 bar to 500 bar, or any subset thereof.

The electrolysis cell 102 may compress the hydrogen. In embodiments where the electrolysis cell 102 functions to compress the hydrogen, the water pressure may be equal to or less than the hydrogen pressure, such as at least 10 bar, 20 bar, 50 bar, or even 100 bar lower than the hydrogen pressure. Without being limited by theory, it may be more efficient to have a water pressure less than the hydrogen pressure as compressing hydrogen electrochemically is believed to be more efficient than compressing the water or hydrogen mechanically.

The electrolysis cell 102 may be operated at a voltage of greater than Eceu, such as greater than 1.23 V, greater than 1.25 V, greater than 1.5 V, greater than 2 V, from 1.23 V to 5 V, from 1.3 V to 5 V, from 1.5 V to 5 V, from 2 V to 5 V, or any subset thereof. Generally, higher voltages will result in increased electrolysis rates. However, operation above a threshold voltage (such as 5 V) may result in the electrolysis of the electrodes rather than the electrolysis of water.

The source of electricity 104 to the electrolysis cell 102 for the totality of the process is not produced from energy provided by the combustion of hydrocarbons. Energy provided by the combustion of hydrocarbons includes electricity produced in a turbine using steam generated from the partial or total combustion of hydrocarbons. Although similar processes have used external sources of electricity for startup, they transitioned to the electricity produced from the combustion of hydrocarbons as quickly as possible and thus did not operate on the source of electricity 104 not produced from energy provided by the combustion of hydrocarbon for the totality of the process. In embodiments, at least 80%, at least 90%, at least 95%, at least 99%, or even at least 99.99% of the electricity used to operate the electrolysis cell for the totality of the process may not be produced from energy provided by the combustion of hydrocarbons.

As discussed previously, it was conventionally assumed that when operating an integrated electrolysis/hydrocarbon gasification process, the most efficient solution would be to utilize waste heat generated from the gasification process to provide electricity to the electrolysis cell 102. However, such a process would not produce green hydrogen due to the use of electricity generated by the combustion of hydrocarbons. Without green hydrogen, it would not be possible to produce cyan hydrogen, for which there is now a market need.

The source of electricity 104 may be external to the process for producing hydrogen. In embodiments, the source of electricity 104 may be solar (such as solar photo voltaic or solar thermal), wind, hydroelectric, geothermal, tidal, nuclear power, or a combination thereof. In embodiments, the external source of electricity 104 may be “green” (emitting no carbon dioxide per marginal unit of electricity generated).

As mentioned previously, the process for producing hydrogen may comprise partially oxidizing (such as in a partial oxidation gasification reactor 114) a hydrocarbon feedstock 116 with the oxygen stream 112 to produce a synthesis gas 120 comprising hydrogen and carbon monoxide; passing the synthesis gas 120 and a water stream 136 to a heat exchanger 110 to produce steam 126 and cool the synthesis gas (thereby providing a cooled synthesis gas 122); and reacting at least a portion of the cooled synthesis gas 122 from the heat exchanger 110 and at least a portion of the steam 126 from the heat exchanger 110 in a water-gas shift reactor 124 to produce carbon dioxide (CO₂) 130 and additional hydrogen 128.

The hydrocarbon feedstock 116 may comprise any hydrocarbon suitable for gasification, such as natural gas, bunker fuel, coal, tar, crude oil, or crude oil distillate fractions (such as vacuum residue or naphtha). In embodiments, the hydrocarbon feedstock may have an initial boiling point of greater than 400° C., such as greater than 450° C., greater than 475° C., greater than 500° C., greater than 525° C., greater than 550° C., greater than 575° C., or even greater than 600° C. In embodiments, the hydrocarbon feedstock 116 may have an end boiling point of at least 700° C., such as at least 750° C., at least 800° C., at least 850° C., at least 900° C., at least 950° C., at least 1000° C., from 700° C. to 1000° C., or any subset thereof.

The process for producing hydrogen may further comprise producing a hydrocarbon feedstock 116 from a crude oil. In embodiments, the process for producing a hydrocarbon feedstock 116 from a crude oil may comprise introducing a crude oil feedstock into an atmospheric distillation unit to produce atmospheric distillate and atmospheric residue; recovering the atmospheric residue from the atmospheric distillation unit and introducing the atmospheric residue as a feedstock into a vacuum distillation unit to produce vacuum distillate and a vacuum residue. The vacuum residue may be used as the hydrocarbon feedstock.

The crude oil may be a raw hydrocarbon which has not been previously processed, such as through one or more of distillation, cracking, hydroprocessing, desalting, or dehydration. In embodiments, the crude oil may have undergone at least some processing, such as desalting, solids separation, scrubbing, desulfurization, or combinations of these, but has not been subjected to distillation. For instance, the crude oil may be a de-salted crude oil that has been subjected to a de-salting process. In embodiments, crude oil may not have undergone pretreatment, separation (such as distillation), or other operation that changes the hydrocarbon composition of the crude oil prior to introducing the crude oil to the process. As used herein, the “hydrocarbon composition” of the crude oil refers to the composition of the hydrocarbon constituents of the crude oil and does not include entrained non-hydrocarbon solids, salts, water, or other non-hydrocarbon constituents.

The crude oil may have an American Petroleum Institute (API) gravity of from 10 to 51. For example, the crude oil may have an API gravity from 27 to 45, from 27 to 43, from 27 to 40, from 27 to 35, from 30 to 34, from 30 to 33, from 30 to 32, or of about 31. The crude oil may have a density of greater than 0.8 grams per milliliter (g/ml), greater than 0.82 g/ml, greater than 0.84 g/ml, 0.86 g/ml, 0.88 g/ml, greater than 0.90 g/ml, greater than 0.91 g/ml, from 0.8 g/ml to 1.0 g/ml, from 0.84 to 0.96 g/ml, from 0.86 g/ml to 0.93 g/ml, from 0.88 g/ml to 0.92 g/ml, from 0.9 g/ml to 0.92 g/ml, or any subset thereof, at a temperature of 15 degrees Celsius. According to some embodiments, the crude oil may be an Arab light crude oil.

The crude oil may have an initial boiling point from 30° C. to 50° C. For example, the crude oil may have an initial boiling point from 30° C. to 45° C., from 30° C. to 40° C., from 30° C. to 35° C., from 35° C. to 50° C., from 40° C. to 50° C., from 45° C. to 50° C., or any subset thereof. The initial boiling point may be determined according to standard test method ASTM D7169.

The crude oil may have an end boiling point (also referred to herein as “EBP” and “FBP”) greater than 720 degrees Celsius. For example, the crude oil may have an end boiling point greater than 740° C., greater than 760° C., greater than 780° C., greater than 800° C., greater than 850° C., greater than 900° C., greater than 950° C., or greater than 1000° C. The crude oil may have an end boiling point less than 2000° C., less than 1800° C., less than 1600° C., less than 1400° C., less than 1200° C., less than 1000° C., less than 900° C., less than 800° C., less than 750° C., or any subset thereof. The end boiling point may be determined according to standard test method ASTM D7169.

Partially oxidizing the hydrocarbon feedstock 116 refers to the process of converting oxygen and hydrocarbons in the hydrocarbon feedstock 116 to synthesis gas 120 (a mixture of hydrogen and carbon monoxide). Generally, the quantity of oxygen supplied should be high enough that sufficient quantities of carbon monoxide are formed yet low enough to prevent the over-oxidation of the carbon monoxide to carbon dioxide. Partially oxidizing the hydrocarbon feedstock 116 may occur in a single reactor or multiple reactors in series.

Conventionally, the oxygen would be produced through air separation processes, which are expensive in terms of both capital and operational costs. Utilizing oxygen produced in the electrolysis cell 102 in the partial oxidation step may eliminate the need for the production of oxygen through the air separation.

Partially oxidizing the hydrocarbon feedstock 116 may occur in a moving bed reactor, a fluidized bed reactor, or an entrained-flow reactor. Without being limited by theory, it is believed that although each of the reactors may be used to process hydrocarbons, it may be more efficient to process liquid hydrocarbon feedstocks 116 in entrained-flow reactors.

Partially oxidizing the hydrocarbon feedstock 116 may occur in a partial oxidation gasification reactor 114 comprising walls and the walls may be refractory or membrane. The refractory walls may comprise oxides, carbides, nitrides, or mixtures thereof of Si, Al, Mg, Ca, B, Cr, Zr, or mixtures thereof.

Generally, in a partial oxidation gasification reactor equipped with membrane walls, the reactor may use a cooling screen protected by a layer of refractory material to provide a surface on which molten ash solidifies and flows downwardly to the quench zone at the bottom of the reactor. The combination of water-cooling behind the walls and a layer of ash which forms on the walls together protect the walls. In the membrane wall reactor, the ash layer is renewed continuously with the deposit of solids on the relatively cool surface. The solids that form the ash may be part of the hydrocarbon feed. Where the hydrocarbon feed contains insufficient ash forming material, it may be supplemented or provided entirely by a source of ash in a separate feed. In embodiments, the process for producing hydrogen may comprise mixing ash-forming material 118 with the hydrocarbon feedstock 116 upstream of the partial oxidation gasification reactor, wherein the partial oxidation gasification reactor is equipped with membrane walls. In embodiments, an ash content of the mixture of ash-forming material 118 with hydrocarbon feedstock 116 may be in the range of from 2 wt. % to 10 wt. %, such as from 4 wt. % to 10 wt. %, from 6 wt. % to 10 wt. %, from 8 wt. % to 10 wt. %, from 2 wt. % to 8 wt. %, from 2 wt. % to 6 wt. %, from 2 wt. % to 4 wt. %, or any subset thereof.

Partially oxidizing the hydrocarbon feedstock 116 may occur at a temperature of from 900° C. to 1800° C., such as from 1000° C. to 1800° C., from 1100° C. to 1800° C., from 1200° C. to 1800° C., from 1400° C. to 1800° C., from 1600° C. to 1800° C., from 900° C. to 1600° C., from 900° C. to 1400° C., from 900° C. to 1200° C., from 1100° C. to 1600° C., or any subset thereof.

Partially oxidizing the hydrocarbon feedstock 116 may occur at a pressure of from 20 bar to 100 bar, such as from 20 bar to 80 bar, from 20 bar to 60 bar, from 40 bar to 100 bar, from 60 bar to 100 bar, from 80 bar to 100 bar, from 40 bar to 80 bar, or any subset thereof.

Partially oxidizing the hydrocarbon feedstock 116 may occur at a mole ratio of oxygen-to-carbon of from 0.5:1 to 10:1, such as from 1:1 to 5:1 or from 1:1 to 2:1. The oxygen in the partial oxidation reactor may come from both the hydrocarbon feedstock 116 itself and the oxygen stream 112 supplied from the electrolysis cell 102. In embodiments, at least 80 mol. %, at least 90 mol. %, at least 95 mol. %, or even at least 99 mol. % of the oxygen in the partial oxidation reactor may have been supplied by the hydrocarbon feedstock 116 and the oxygen stream 112 from the electrolysis cell 102.

Partially oxidizing the hydrocarbon feedstock 116 may occur in the presence of steam 126 and a steam to carbon ratio of from 0.1:1 to 10:1, such as from 0.1:1 to 2:1 or from 0.4:1 to 0.6:1. The steam 126 may be supplied from the heat exchanger 110. In embodiments, at least 80 wt. %, at least 90 wt. %, at least 95 wt. %, or at least 99 wt. % of the steam 126 may be supplied from the heat exchanger 110.

Partially oxidizing the hydrocarbon feedstock 116 may produce a synthesis gas 120. The synthesis gas 120 may comprise water, oxygen, hydrogen, carbon monoxide, and carbon dioxide. In embodiments, the synthesis gas 120 may comprise at least 70 mol. %, at least 80 mol. %, at least 90 mol. %, at least 95 mol. %, or even at least 99 mol. % of water, oxygen, hydrogen, carbon monoxide, and carbon dioxide. In further embodiments, the synthesis gas 120 may comprise at least 50 mol. %, at least 70 mol. %, at least 80 mol. %, at least 90 mol. %, at least 95 mol. %, or even at least 99 mol. % of hydrogen and carbon monoxide.

As produced, the synthesis gas 120 may have a temperature of from 900° C. to 1800° C., such as from 1000° C. to 1800° C., from 1100° C. to 1800° C., from 1200° C. to 1800° C., from 1400° C. to 1800° C., from 1600° C. to 1800° C., from 900° C. to 1600° C., from 900° C. to 1400° C., from 900° C. to 1200° C., from 1100° C. to 1600° C., or any subset thereof.

The process for producing hydrogen may comprise passing the synthesis gas 120 and a water stream 136 to a heat exchanger 110 to produce steam 126 and cool the synthesis gas (thereby providing a cooled synthesis gas 122). The water stream 136 may be preheated using waste heat from the electrolysis cell 102.

The cooled synthesis gas 122 may have a temperature of from 150° C. to 400° C., such as from 150° C. to 300° C., from 150° C. to 200° C., from 200° C. to 400° C., from 300° C. to 400° C., from 200° C. to 300° C., or any subset thereof.

The process for producing hydrogen may further comprise combusting hydrogen (such as from hydrogen stream 108) and oxygen (such as from oxygen stream 112) from the electrolysis cell 102 to produce heat. This heat may be used to convert more of the water stream 136 to steam. Additionally, the combustion of hydrogen and oxygen produces water, which may be in the form of steam. The process for producing hydrogen may comprise introducing at least a portion of the steam from the combustion of hydrogen (such as from hydrogen stream 108) and oxygen (such as from oxygen stream 112) to the water-gas shift reactor 124. It was counterintuitively found that combusting at least a portion of the hydrogen from the electrolysis cell 102 in process of generating steam can decrease the overall carbon dioxide emissions of the process 100.

The hydrogen may be combusted in the heat exchanger 110, or in a separate boiler or reactor, upstream of the heat exchanger 110.

The process for producing hydrogen may comprise introducing at least a portion of the cooled synthesis gas 122 from the heat exchanger 110, and at least a portion of the steam 126 from the heat exchanger 110 into a water-gas shift reactor 124 to produce carbon dioxide (CO₂) 130 and additional hydrogen 128.

Within the water-gas shift reactor 124, the steam 126 and cooled synthesis gas 122 may undergo the water-gas shift reaction. The reaction proceed as follows:

CO+H₂O [symbol] CO₂+H₂ (3)

The carbon monoxide and steam may contact one another in the water-gas shift reactor 124 in the presence of a water-gas shift catalyst. The water-gas shift catalyst may comprise metals or metal oxides, such as Cu, CuO, Fe, Fe₂O₃, Cr, Cr₂O₃, Mg, MgO, Zn, ZnO, Al, Al₂O₃, or combinations thereof.

The environment within the water-gas shift reactor 124 may comprise at least 80 mol. %, at least 90 mol. %, at least 95 mol. %, or even at least 99 mol. % of the combined molality of hydrogen, carbon dioxide, carbon monoxide, and water, on the basis of all gaseous compounds within the water-gas shift reactor 124.

The water-gas shift reactor 124 may be operated at a temperature in the range of from 150° C. to 400° C., such as from 200° C. to 400° C., from 300° C. to 400° C., from 150° C. to 300° C., from 150° C. to 200° C., from 200° C. to 300° C., or any subset thereof.

The water-gas shift reactor 124 may be operated at a pressure in the range of from 1 bar to 60 bar, such as from 1 bar to 50 bar, from 1 bar to 40 bar, from 1 bar to 30 bar, from 1 bar to 20 bar, from 1 bar to 10 bar, from 10 bar to 60 bar, from 20 bar to 60 bar, from 30 bar to 60 bar, from 40 bar to 60 bar, from 50 bar to 60 bar, or any subset thereof.

The water-gas shift reactor 124 may be operated at a mole ratio of water-to-carbon monoxide in the range of from 5:1 to 3:1, such as from 5:1 to 4:1, from 4:1 to 3:1, or any subset thereof.

In embodiments, at least 80 wt. %, at least 90 wt. %, at least 95 wt. %, or even at least 99 wt. % of the steam 126 from the heat exchanger 110 may be supplied to the water-gas shift reactor 124 and, optionally to the partial oxidation gasification reactor 114.

The hydrogen produced in the water-gas shift reactor 124 may be gray hydrogen or blue hydrogen. The hydrogen is considered gray if the CO₂ produced in the water-gas shift reactor 124 is released to the atmosphere. The hydrogen is considered blue if the CO₂ produced in the water-gas shift reactor 124 is captured and stored.

The process for producing hydrogen may comprise combining the hydrogen stream 108 from the electrolysis cell 102 (“green” hydrogen) and the hydrogen stream 128 from the water-gas shift reactor 124 (“blue” hydrogen) to produce a combined hydrogen stream 134 (“cyan” hydrogen). The combined hydrogen stream 134 may be compressed.

The hydrogen may be compressed electrochemically (using an electrochemical cell, such as a PEM electrochemical cell), physically using turbopumps/compressors, cryogenically, or a combination of these.

The compressed hydrogen stream may be stored and sent to uses external to the refinery or may be sent to a refinery process unit. Suitable refinery process units include, for example, hydrotreaters, hydrocrackers, hydroprocessors, isomerization units, and catalytic reformers. Suitable external processes include electrical generation units, such as fuel cells; internal combustion engines configured to operate on hydrogen; metallurgy facilities; cement production; domestic uses (such as stoves, water heaters, and home heating apparatuses).

The process for producing hydrogen may comprise capturing and storing the CO₂ 130 produced. The CO₂ 130 may be captured using absorption solvent-based methods, adsorption-physical separation, membrane separation, chemical looping combustion (CLC) and calcium looping process, cryogenic methods, absorption-based post-combustion capture methods, or a combination thereof. At least a portion of the energy required for CO₂ capture may be provided by the steam generated in the heat exchanger, such as thermal energy used in the adsorption based processes. The captured CO₂ 130 may be stored or converted into chemicals, such as methanol.

According to a first aspect, a process for producing hydrogen comprises operating an electrolysis cell with a source of electricity to produce an oxygen stream and a hydrogen stream from water, wherein the source of electricity to the electrolysis cell for the totality of the operation of the electrolysis cell is not produced from energy provided by the combustion of hydrocarbons; reacting a hydrocarbon feedstock with the oxygen stream to partially oxidize the hydrocarbon feedstock, thereby producing a synthesis gas comprising hydrogen and carbon monoxide; passing the synthesis gas and a water stream to a heat exchanger to produce steam and to cool the synthesis gas; and reacting at least a portion of the synthesis gas from the heat exchanger and at least a portion of the steam from the heat exchanger in a water-gas shift reactor to produce carbon dioxide and additional hydrogen.

According to a second aspect, in conjunction with the first aspect, the process further comprises combusting hydrogen and oxygen from the electrolysis cell to produce steam and heat; and introducing at least a portion of the steam from the combustion of hydrogen and oxygen to the water-gas shift reactor.

According to a third aspect, in conjunction with either of aspects 1 or 2, the hydrocarbon feedstock has an initial boiling point of greater than 500° C.

According to a fourth aspect, in conjunction with any one of aspects 1 to 3, the hydrocarbon feedstock is vacuum residue, natural gas, naphtha, bunker fuel, coal, crude oil, or crude oil distillate fractions.

According to a fifth aspect, in conjunction with any one of aspects 1 to 4, the process further comprises introducing a crude oil feedstock into an atmospheric distillation unit to produce atmospheric distillate and atmospheric residue; recovering the atmospheric residue from the atmospheric distillation unit and introducing it as a feedstock into a vacuum distillation unit to produce vacuum distillate and a vacuum residue, wherein the hydrocarbon feedstock is the vacuum residue.

According to a sixth aspect, in conjunction with any one of aspects 1 to 5, the process further comprises capturing and storing the produced CO₂.

According to a seventh aspect, in conjunction with any one of aspects 1 to 6, the process further comprises combining the hydrogen from the electrolysis cell and the hydrogen from the water-gas shift reactor to produce hydrogen; and compressing the hydrogen and sending the hydrogen to a refinery process unit.

According to an eighth aspect, in conjunction with any one of aspects 1 to 7, the refinery process unit is a hydrotreater, a hydrocracker, a hydroprocessor, an isomerization unit, or a catalytic reformer.

According to a ninth aspect, in conjunction with any one of aspects 1 to 8, the process further comprises mixing ash-forming material with the hydrocarbon feedstock upstream of the partial oxidation gasification reactor to cool the exterior walls of the partial oxidation gasification reactor.

According to a tenth aspect, in conjunction with any one of aspects 1 to 9, wherein partially oxidizing the hydrocarbon feedstock occurs at a temperature in a range of from 900° C. to 1800° C. and a pressure in a range of from 20 bar to 100 bar.

According to an eleventh aspect, in conjunction with any one of aspects 1 to 10, wherein partially oxidizing the hydrocarbon feedstock occurs at a mole ratio of oxygen-to-carbon content of the feedstock in a range of from 0.5:1 to 10:1.

According to a twelfth aspect, in conjunction with any one of aspects 1 to 11, wherein the wherein partially oxidizing the hydrocarbon feedstock occurs in a membrane wall gasification reactor and the membrane wall gasification reactor is operated at a mole ratio of steam-to-carbon content of the feedstock in a range of from 0.1:1 to 10:1.

According to a thirteenth aspect, in conjunction with any one of aspects 1 to 12, wherein the water-gas shift reactor is operated at a temperature in a range of from 150° C. to 400° C., a pressure in a range of from 1 bar to 60 bar, and a mole ratio of water-to-carbon monoxide in a range of from 5:1 to 3:1.

According to a fourteenth aspect, in conjunction with any one of aspects 1 to 13, wherein the wherein partially oxidizing the hydrocarbon feedstock occurs in a moving bed reactor, a fluidized bed reactor, or an entrained-flow reactor.

According to a fifteenth aspect, in conjunction with any one of aspects 1 to 14, wherein partially oxidizing the hydrocarbon feedstock occurs in a partial oxidation gasification reactor comprising walls and the walls are refractory or membrane.

According to a sixteenth aspect, in conjunction with any one of aspects 1 to 15, wherein an ash content of the mixture of ash-forming material with hydrocarbon feedstock is in a range of from 2 to 10 wt. %.

According to a seventeenth aspect, in conjunction with any one of aspects 1 to 16, wherein the electrolysis cell is operated at a temperature in a range from 10° C. to 70° C., a pressure of from 1 bar to 30 bar, and a voltage of from 1.23 V to 5V.

According to an eighteenth aspect, in conjunction with any one of aspects 1 to 17, wherein the external source of electricity is produced from solar energy, wind energy, hydroelectric energy, geothermal energy, tidal energy, or a combination thereof.

According to a nineteenth aspect, in conjunction with any one of aspects 1 to 18, wherein the CO₂ is captured using absorption solvent-based methods, adsorption-physical separation, membrane separation, chemical looping combustion (CLC) and calcium looping process, cryogenic methods, absorption-based post-combustion capture methods, or a combination thereof.

According to a twentieth aspect, in conjunction with any one of aspects 1 to 19, wherein waste heat from the electrolysis cell is used to preheat the water input to the heat exchanger.

### EXAMPLES

The following examples are provided to illustrate embodiments described in this disclosure and are not intended to limit the scope of this disclosure or its appended claims.

### Materials

For all examples, an Arab Light Crude Oil is used as the hydrocarbon feedstock. The properties of the hydrocarbon feedstock are given in Table 1.

TABLE 1

| Name | Crude Oil |
|---|---|
| Specific Gravity | 0.869 |
| API Gravity, ° | 31.4 |
| Sulfur, W % | 1.94 |
| Nitrogen, ppmw | 842 |
| MCR, W % | 5.36 |
| C5-Asphalthenes, W % | 2.45 |
| Ni, ppmw | 5 |
| V, ppmw | 17 |

### Comparative Example 1: Hydrocarbon Gasification Alone

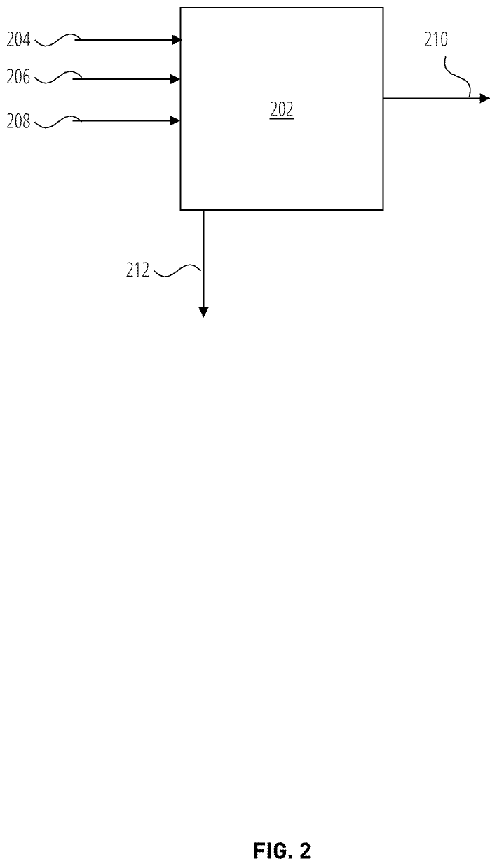

As depicted in FIG. 2, a partial oxidation and water-gas shift reactor 202 is simulated. The reactor includes a partial oxidation reaction zone (non-catalytic) and a water-gas shift reaction zone (catalytic), both of which are operated at 1045° C. and 28 bar. The ratio of steam-to-carbon is 1:1 by weight. The ratio of oxygen-to-carbon is 1:1 by weight. Typical yields for a commercial operation with the recited reaction configuration is used to produce a material balance, shown in Table 2.

TABLE 2

| Stream# | Stream Name | Unit | Quantity |
|---|---|---|---|
| 204 | Hydrocarbon Feedstock | Kg | 1,000 |
| 206 | Oxygen | Kg | 1,000 |
| 208 | Steam | Kg | 502 |
| 210 | Hydrogen | Kg | 281 |
| 212 | CO₂ | Kg | 2,956 |

As is shown in Table 2, the gasification of the hydrocarbon feedstock produces 281 kg of hydrogen and 2,956 Kg of CO₂. If the produced CO₂ is released to the atmosphere, the hydrogen is referred to as gray hydrogen, if the CO₂ is captured and stored the hydrogen is referred to as blue hydrogen. Ignoring any energy required for CO₂ capture and storage, the amount of hydrogen produced per unit of hydrocarbon feedstock will be the same.

### Example 2

As depicted in FIG. 1, the process for producing hydrogen is operated. The partial oxidation gasification reactor is operated at a temperature of 1045° C., a pressure of 28 bar, an oxygen to carbon mass ratio of 1.26, and a steam to carbon mass ratio of 0.6. The water-gas shift reactor is operated at a temperature of 318° C., a pressure of 1 bar, a steam to carbon monoxide mole ratio of 3:1. The water-gas shift reactor catalyst is a Cu—Zn—Al catalyst. An alkaline electrolysis cell is operated at a voltage of 1.85 V, a temperature of 25° C., and a pressure of 1 atm. The mass balance is provided in Table 3. As is shown in Table 3, the integrated process produces 112 kg of green hydrogen and 228 Kg of blue hydrogen, resulting in 340 Kg of cyan hydrogen.

TABLE 3

| Stream# | Stream Name | Unit | Value |
|---|---|---|---|
| 106 | Pure Water | Kg | 1,000 |
| 104 | External Source of Electricity | MWh | 6,324 |
| 108 | Hydrogen | Kg | 112 |
| 112 | Oxygen from Electrolysis | Kg | 889 |
| 142 | Oxygen to Heat Exchanger | Kg | 94 |
| 144 | Oxygen to the Partial Oxidation Reactor | Kg | 795 |
| 140 | “green” Hydrogen | Kg | 100 |
| 136 | Water | Kg | 407 |
| 138 | Hydrogen to Heat Exchanger | Kg | 12 |
| 126 | Steam from Heat Exchanger to Water-Gas Shift | Kg | 513 |
| | Reactor | | |
| 116 | Hydrocarbon feedstock | Kg | 1,000 |
| 118 | Ash Forming Material | Kg | — |
| 128 | Blue Hydrogen | Kg | 228 |
| 130 | CO₂ | Kg | 2,956 |
| 134 | “Cyan” Hydrogen | Kg | 340 |

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A process for producing hydrogen, the process comprising:
operating an electrolysis cell with a source of electricity to produce an oxygen stream and a hydrogen stream from water, wherein the source of electricity to the electrolysis cell for the totality of the operation of the electrolysis cell is not produced from energy provided by the combustion of hydrocarbons;
reacting a hydrocarbon feedstock with the oxygen stream to partially oxidize the hydrocarbon feedstock, thereby producing a synthesis gas comprising hydrogen and carbon monoxide;
passing the synthesis gas and a water stream to a heat exchanger to produce steam and to cool the synthesis gas; and
reacting at least a portion of the synthesis gas from the heat exchanger and at least a portion of the steam from the heat exchanger in a water-gas shift reactor to produce carbon dioxide and additional hydrogen.

2. The process for producing hydrogen of claim 1, further comprising:
combusting hydrogen and oxygen from the electrolysis cell to produce steam and heat; and
introducing at least a portion of the steam from the combustion of hydrogen and oxygen to the water-gas shift reactor.

3. The process for producing hydrogen of claim 1, wherein the hydrocarbon feedstock has an initial boiling point of greater than 500° C.

4. The process for producing hydrogen of claim 1, wherein the hydrocarbon feedstock is vacuum residue, natural gas, naphtha, bunker fuel, coal, crude oil, or crude oil distillate fractions.

5. The process for producing hydrogen of claim 1, further comprising:
introducing a crude oil feedstock into an atmospheric distillation unit to produce atmospheric distillate and atmospheric residue;
recovering the atmospheric residue from the atmospheric distillation unit and introducing it as a feedstock into a vacuum distillation unit to produce vacuum distillate and a vacuum residue, wherein the hydrocarbon feedstock is the vacuum residue.

6. The process for producing hydrogen of claim 1, further comprising capturing and storing the produced CO₂.

7. The process for producing hydrogen of claim 1, further comprising:
combining the hydrogen from the electrolysis cell and the hydrogen from the water-gas shift reactor to produce hydrogen; and
compressing the hydrogen and sending the hydrogen to a refinery process unit or sending the hydrogen to an external process.

8. The process for producing hydrogen of claim 7, wherein the refinery process unit is a hydrotreater, a hydrocracker, a hydroprocessor, an isomerization unit, or a catalytic reformer.

9. The process for producing hydrogen of claim 1, further comprising mixing ash-forming material with the hydrocarbon feedstock upstream of the partial oxidation gasification reactor to cool the exterior walls of the partial oxidation gasification reactor.

10. The process for producing hydrogen of claim 1, wherein partially oxidizing the hydrocarbon feedstock occurs at a temperature in a range of from 900° C. to 1800° C. and a pressure in a range of from 20 bar to 100 bar.

11. The process for producing hydrogen of claim 1, wherein partially oxidizing the hydrocarbon feedstock occurs at a mole ratio of oxygen-to-carbon content of the feedstock in a range of from 0.5:1 to 10:1.

12. The process for producing hydrogen of claim 1, wherein the wherein partially oxidizing the hydrocarbon feedstock occurs in a membrane wall gasification reactor and the membrane wall gasification reactor is operated at a mole ratio of steam-to-carbon content of the feedstock in a range of from 0.1:1 to 10:1.

13. The process for producing hydrogen of claim 1, wherein the water-gas shift reactor is operated at a temperature in a range of from 150° C. to 400° C., a pressure in a range of from 1 bar to 60 bar, and a mole ratio of water-to-carbon monoxide in a range of from 5:1 to 3:1.

14. The process for producing hydrogen of claim 1, wherein the wherein partially oxidizing the hydrocarbon feedstock occurs in a moving bed reactor, a fluidized bed reactor, or an entrained-flow reactor.

15. The process for producing hydrogen of claim 1, wherein partially oxidizing the hydrocarbon feedstock occurs in a partial oxidation gasification reactor comprising walls and the walls are refractory or membrane.

16. The process for producing hydrogen of claim 9, wherein an ash content of the mixture of ash-forming material with hydrocarbon feedstock is in a range of from 2 to 10 wt. %.

17. The process for producing hydrogen of claim 1, wherein the electrolysis cell is operated at a temperature in a range from 10° C. to 70° C., a pressure of from 1 bar to 30 bar, and a voltage of from 1.23 V to 5V.

18. The process for producing hydrogen of claim 1, wherein the external source of electricity is produced from solar energy, wind energy, hydroelectric energy, geothermal energy, tidal energy, or a combination thereof.

19. The process for producing hydrogen of claim 6, wherein the CO₂ is captured using absorption solvent-based methods, adsorption-physical separation, membrane separation, chemical looping combustion (CLC) and calcium looping process, cryogenic methods, absorption-based post-combustion capture methods, or a combination thereof.

20. The process for producing hydrogen of claim 1, wherein waste heat from the electrolysis cell is used to preheat the water input to the heat exchanger.
